(19) United States
(12) Patent Application Publication
(10) Pub. No.: US 2018/0150742 A1
(43) Pub. Date: May 31, 2018

(54) SOURCE CODE BUG PREDICTION

(71) Applicant: MICROSOFT TECHNOLOGY LICENSING, LLC., REDMOND, WA (US)

(72) Inventors: MUIRIS WOULFE, DUBLIN (IE); POORNIMA MUTHUKUMAR, SEATTLE, WA (US); ALBERT AGRAZ SANCHEZ, ZURICH (CH); YUANYUAN DONG, BELLEVUE, WA (US); SONAL KUMAR, UTTAR PRADESH (IN); MAKSAT MARATOV, DUBLIN (IE); MARCIN MOZEJKO, WARSAW (PL); PIOTR SARNICKI, BOGACICA (PL); ANIKET VIDYADHAR PEDNEKAR, LOS ANGELES, CA (US)

(21) Appl. No.: 15/362,744

(22) Filed: Nov. 28, 2016

(51) Int. Cl. G06N 3/08; G06F 11/36; G06N 99/00

(52) U.S. Cl. CPC G06N 3/08; G06N 99/005; G06F 11/362

(57) ABSTRACT

A probabilistic machine learning model is generated to identify potential bugs in a source code file. Source code files with and without bugs are analyzed to find features indicative of a pattern of the context of a software bug, wherein the context is based on a syntactic structure of the source code. The features may be extracted from a line of source code, a method, a class and/or any combination thereof. The features are then converted into a binary representation of feature vectors that train a machine learning model to predict the likelihood of a software bug in a source code file.

### BACKGROUND

During the development of a program or software, a range of measures is taken to ensure that the program is tested prior to the release and distribution of the program. These measures are aimed at reducing the number of bugs in the program in order to improve the quality of the program. A bug in a source code program is an unintended state in the executing program that results in undesired behavior. Regardless of these measures, the program may still contain bugs.

Software maintenance makes the corrective measures needed to fix software bugs after the bugs are reported by end users. Fixing the software bugs after deployment of the program hampers the usability of the deployed program and increases the cost of the software maintenance services. A better solution would be to detect and fix the software bugs prior to release of the program.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A machine learning model is trained to predict the probability of a software bug in a source code file. The model is trained during a training phase that mines source code repositories for source code files having source code statements with and without software bugs. Features associated with the syntactic structure or context of the source code file is then extracted for analysis in order to generate feature vectors that train the machine learning model. The feature vectors may represent syntactic information from each line of source code, from each method in a source code file, and for each class of a source code file and/or any combination thereof. The feature vectors are used to train a machine learning model to determine the likelihood that a source code bug is present in a target source code file.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1A is a block diagram illustrating the various components of a system for training a machine learning model for predicting software bugs.

FIG. 1B is a block diagram illustrating the various components of a system for executing the machine learning model on a target source code file.

FIG. 2 is a flow diagram of an exemplary method for mining source code repositories for training and testing data.

FIG. 3 is an exemplary illustration of the operations of the data mining engine on an exemplary program.

FIG. 4 is a flow diagram of an exemplary method of the code analysis engine in generating the training data.

FIG. 5 is an exemplary illustration of the operations of the code analysis engine on an exemplary program.

FIG. 6 is a flow diagram of an exemplary method of the training engine.

FIG. 7 is a flow diagram of an exemplary method of the execution phase.

FIG. 8 is an exemplary illustration of the operation of a training phase that incorporates syntactic information into a source code file.

FIGS. 9A-9B are exemplary illustrations of a system that utilizes metrics to train and execute a machine learning model to predict software bugs.

FIGS. 10A-10D are exemplary illustrations of the output generated by a virtualization engine.

FIG. 11 is a block diagram illustrating an exemplary computing or operating environment.

### DETAILED DESCRIPTION

Overview

The subject matter disclosed herein discloses a mechanism for predicting software bugs in a source code file. The mechanism analyzes various source code files to extract features that represent patterns indicative of a software bug and patterns without a software bug. The features selected best capture the context in which a software bug exists and does not exist in order to train a machine learning model to learn the patterns that identify a software bug. The mechanism described herein utilizes a context that is based on the syntactical structure of the source code. Hence, the machine learning model learns the existence of a software bug from the context where the software bug exists and does not exist.

The subject matter disclosed herein utilizes several different techniques for extracting features representative of the context of software bugs and the context of bug-free source code. In one aspect, each element in a line of source code is converted into a token that represents the element. The line of source code is then represented as a sequence of tokens. The sequence of tokens is then grouped into a window or group that includes sequences of tokens in an aggregated collection of contiguous source code statements. The sequences in a window are then transformed into a binary representation which forms a feature vector that trains a machine learning model, such as a long short term model (LSTM).

In another aspect, a source code file is partially tokenized with each line of source code including a combination of tokens and source code. Each line of source code is analyzed on a character-by-character or chunk-by-chunk basis to identify characters or chunks that are associated with and without a software bug. A chunk has a predetermined number of characters. Contiguous chunks of source code are grouped into a window which is then converted into a binary representation that forms feature vectors that train a machine learning model, such as a recurrent neural network (RNN).

In yet another aspect, metrics representing a measurement of various syntactical elements of a source code file are collected. The metrics may include the number of variables, the number of mathematical operations, the number of a particular data type referenced, the number of loop constructs, the usage of a particular method, and the usage of a particular data type. These metrics may be collected for each line of source code, for each method in a source code file, for each class in a source code file, and/or other groupings deemed appropriate. The metrics are then converted into a binary representation that forms feature vectors which are used to train a potentially simpler machine learning model such as an artificial neural network (ANN).

The feature vectors are constructed from a combination of source code files having a software bug and source code files without a software bug. The feature vectors are then split into data that is used to train the machine learning model and data that is used to test the machine learning model. When the machine learning model is trained to meet a desired level of accuracy, the model is then used to predict the probability of a software bug in a source code file.

A visualization technique is used to display the probabilistic output from the machine learning model in several ways. A visualization engine may be utilized to display each line, method, and/or class of a target source code file with a corresponding probability of a software bug. The probability may be displayed as a numeric value, as an icon, by highlighting portions of the source code in various colors or shading the portion of the source code in a particular style and so forth. In addition, the probabilities may be displayed when they exceed a threshold. However, the subject matter disclosed herein is not constrained to any particular visualization technique, style or format and other formats, styles and techniques may be utilized as desired.

The detection of a software bug differs from performing type checking which uses the syntax of the programming language to find syntax errors. The software bugs referred to herein refer to semantic and logic errors. Semantic errors occur when the syntax of the source code is correct but the semantics or meaning of a portion of the source code is not what is intended. A logic error occurs when the syntax of the source code is correct but the flow of instructions does not perform or produce an intended result. Hence, a software bug affects the behavior of the source code and results in an unintended state and undesired behavior.

Attention now turns to a discussion of the methods, systems, and devices that implement this technique in various aspects.

Source Code Bug Prediction

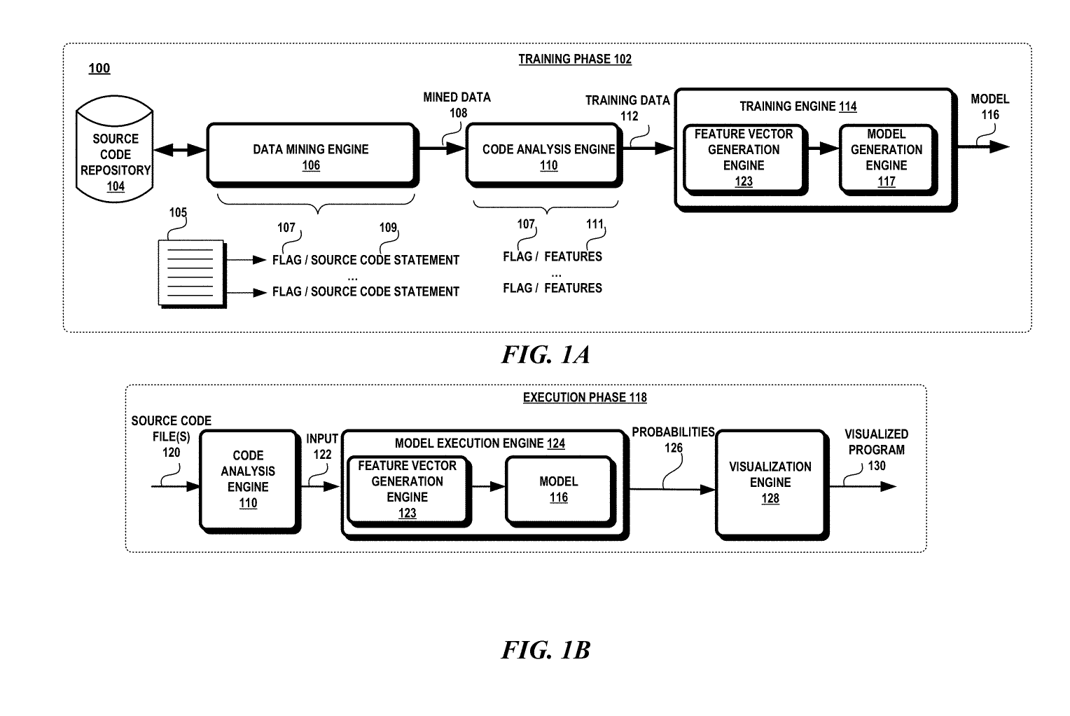

FIG. 1A illustrates an exemplary configuration of a system 100 for training a machine learning model for source code bug prediction. In one aspect of the subject matter disclosed herein, the system 100 executes a training phase 102 that generates a model 116 to predict the likelihood of a software bug in a source code file. The system 100 includes a source code repository 104 coupled to a data mining engine 106. The data mining engine 106 searches or mines the source code repository 104 for one or more source code files having been modified to fix bugs and for source code files that have not had bug fixes. The data mining engine 106 generates mined data 108 that consists of an original source code file 105 with a flag 107 appended to each line or source code statement 109. The flag 107 indicates whether the line has a bug nor not. The mined data 108 is then input to a code analysis engine 110 that analyzes each source code statement in order to extract features which are transformed into training data 112 that includes the flag 107 and the extracted features 111. The training data 112 is analyzed by the training engine 114. The training engine 114 includes a feature vector generation engine 123 and a model generation engine 117. The feature vector generation engine 123 receives the training data 112 and transforms the training data 112 into feature vectors. The feature vectors are then input to the model generation engine 117 to train a probabilistic machine learning model 116 to determine a probability of the existence of a software bug. The training data 112 may be split to train the model 116 and to test the model 116 in any intended manner. In one aspect, the training data 112 may be split so that 60 percent is used to train the model 116 and 40 percent is used to test the model 116. The model 116 is trained to achieve an intended level of accuracy or the maximum accuracy is achievable within a specified number of cycles, epochs, or time.

The code analysis engine 110 analyzes the syntactic structure of the source code files at different granularities to find patterns indicative of a software bug and indicative of no software bugs. In one aspect, lines of source code from source code files with bugs and without bugs are analyzed. Each element in a line of source code is replaced with a token that is based on the grammar of the underlying programming language. The tokens in a window of a contiguous set of source code statements are aggregated to form a feature vector that trains the machine learning model.

In another aspect, a source code file is partially tokenized with each line of source code including a combination of tokens and source code. Each line of source code is analyzed on a character-by-character or chunk-by-chunk basis to identify characters or chunks that are associated with and without software bugs. A chunk is a predetermined number of characters. Certain elements in the source code file are replaced or concatenated with tokens. Contiguous chunks of source code are grouped into a window and the window is then converted into a binary representation or feature vectors that train a machine learning model, such as a recurrent neural network (RNN).

In another aspect, the lines of a source code file can be analyzed with respect to various metrics that measure the number of variables in a line of source code, the number of mathematical operations in a line of source code, the number of a particular data type of elements referenced in a line of source code, the number of loop constructs in a line of source code, the usage of a particular method in a line of source code, and the usage of a particular data type in a line of source code. These features are then used to form feature vectors that train the machine learning model. This technique is simple to implement and has the advantage of allowing a developer to add, delete, and modify the metrics to accommodate the nature of the source code being analyzed.

In yet another aspect of the subject matter disclosed herein, the methods and/or classes in a source code file may be analyzed instead of the lines of source code. Each method and/or class may be analyzed for metrics identifying the type of elements in each method/class, the number of variables in a line of source code, the number of mathematical operations in a line of source code, the number of a particular data type referenced in a line of source code, the number of loop constructs in a line of source code, the usage of a particular method in a line of source code, and the usage of a particular data type in a line of source code, and any combination thereof. These features are then converted into a binary representation or feature vectors that train the machine learning model.

FIG. 1B illustrates an exemplary configuration of an execution phase 118 that utilizes the model to predict the existence of software bugs in a source code file 120. In the execution phase 118, the code analysis engine 110 extracts features from a designated portion (e.g., line, method, class) of a source code file 120 which are then input into a model execution engine 124. The model execution engine 124 includes a feature vector generation engine 123 and the model 116. The feature vector generation engine 123 converts the features or input 122 into feature vectors that is input to the model 116. The model 116 outputs probabilities 126 for each designated portion that indicates the likelihood of a particular source code statement having a bug. The probabilities 126 for each portion of the source code may be input into a visualization engine 128 that identifies potential software bugs.

In one aspect of the subject matter described herein, the visualization engine can be part of a source code editor or an integrated development environment (IDE). In another aspect, the visualization may be part of a user interface, a browser, or other type of application configured to present the source code file and model output in a visual manner.

Attention now turns to a description of the operations for the aspects of the subject matter described with reference to various exemplary methods. It may be appreciated that the representative methods do not necessarily have to be executed in the order presented, or in any particular order, unless otherwise indicated. The exemplary methods may be representative of some or all of the operations executed by one or more aspects described herein and that the method can include more or less operations than that which is described. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints.

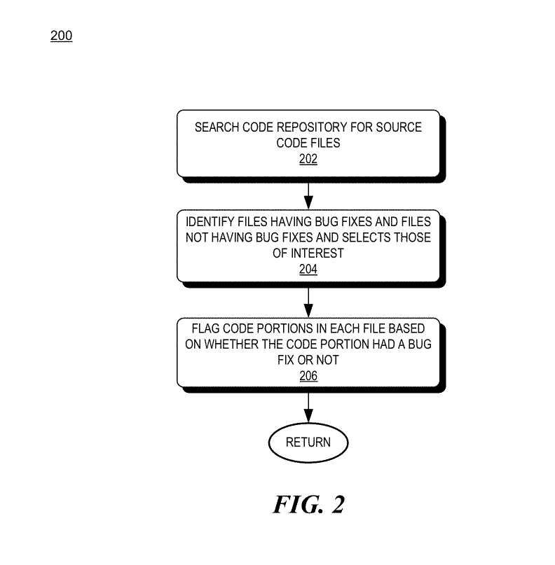

FIG. 2 illustrates a flow diagram of an exemplary method 200 of the data mining engine 106. Referring to FIG. 2, the data mining engine searches a source code repository for exemplary source code files with and without software bugs (block 202). The source code repository may be a version control system such as Apache Subversion or GIT. However, the subject matter disclosed herein is not limited to a source code repository and other sources containing source code may be utilized as well. For example, without limitation, the data mining engine 106 may search source code files belonging to a particular project in an integrated development environment (IDE), and/or search source code files associated with a particular storage location (e.g., directory, cloud storage, etc.).

In aspects where the data mining engine searches a version control repository, the version control system may track changes made to a source code file in a change history or metadata that is recorded in the repository. Alternatively, the data mining engine may collect all the data in a source code file regardless of any modifications made to the source code file to fix a bug. Furthermore, if the history of changes made to the source code file was voluminous, recent changes may be selected in order to reduce the analysis time. If there were major changes made to the source code file, those changes made after the major changes were made may only be considered.

The change history may indicate that the source code file was changed due to a bug fix. The data mining engine searches the change history for those source code files having changes made due to a bug fix. The change history may indicate in which source code statement the bug is located. Based on this search, the data mining engine chooses different source code files in which a change was made for a bug fix and those not having software bugs (block 204). The data mining engine tags each line of a source code file with a flag that identifies whether the line of source code includes a bug or not (block 206). These annotated programs are then input to the code analysis engine.

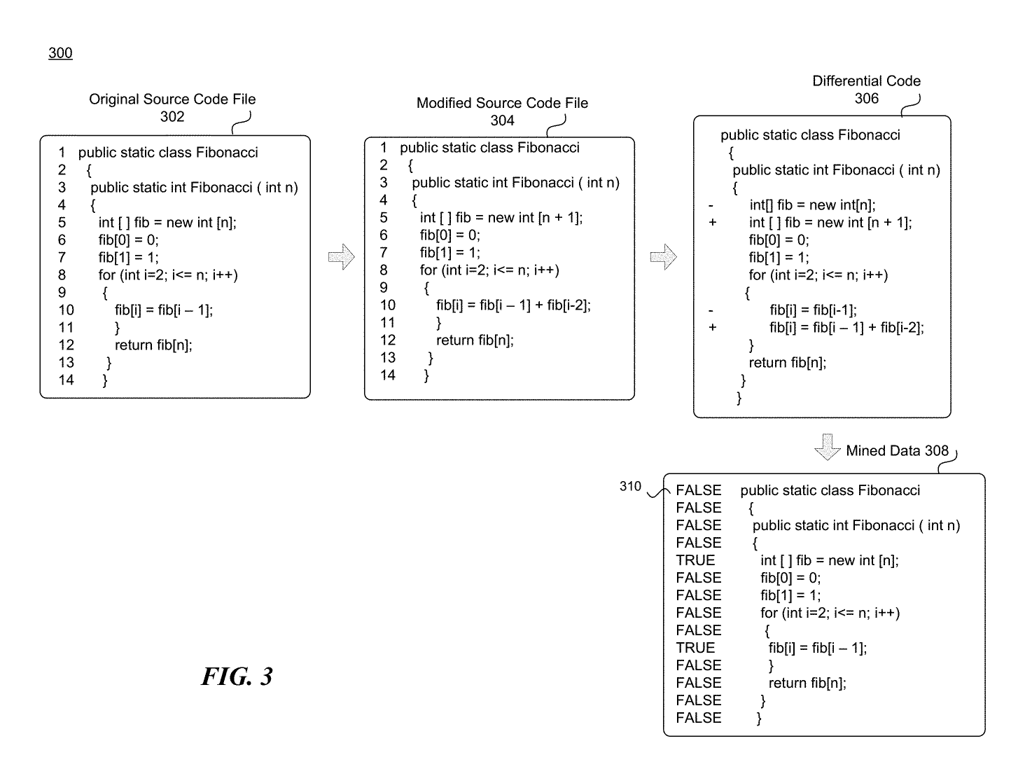

FIG. 3 illustrates exemplary operations 300 of the data mining engine with respect to an exemplary source code file. Turning to FIG. 3, there is shown a portion of an original source code file 302 written in C# having 14 lines of code or source code statements. For the purposes of this example, a source code statement is identified as being a continuous sequence of code elements that ends at a semicolon. This original source code file 302 may be stored in a source code repository. The original source code file 302 may have been checked out of the source code repository. The original source code file 304 shows a modified version of the original source code file 302 which corrects two software bugs at line 5 and 10.

The source code repository may track these changes and attribute them to bug fixes. Differential code 306 illustrates the differences between the original source code file 302 and the modified source code file 304 where the source code statement “int[ ] fib=new int[n]” is annotated with the “−” symbol indicating that the associated code statement was altered. In addition, program 306 shows the source code statement “int[ ] fib=new int[n+1]” annotated with a “+” symbol indicating that the associated code statement is the modification. The data mining engine reads the tracked changes of a source code file (i.e., change sets) and annotates the source code file with a flag that indicates whether or not each source code statement contains a bug. Mined data 308 represents the original source code file 302 annotated with a flag at each line, where the flag “FALSE” denotes that there is no bug in a source code statement and the flag “TRUE” denotes a software bug is in the source code statement. This mined data 308 is then input to the code analysis engine.

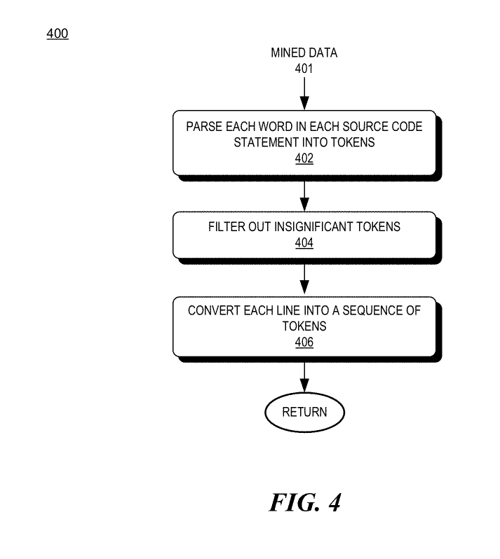

FIG. 4 illustrates a flow diagram of an exemplary method 400 of the code analysis engine 110 during the training phase. The code analysis engine 110 analyzes the mined data 401 to reduce the code input to its essential elements and to identify the more relevant data. The analysis proceeds by parsing each source code statement using the grammar of the programming language of the source code file into tokens (block 402). A token is a lexical atom and the smallest element in the grammar of the source code program's programming language. For example, for a source code statement written in C# that reads “result=input1+input2”, this source code statement would be parsed into a sequence of tokens as follows: “Variable/Assignment Operator/Variable/Addition Operation/Variable/EndOfLine.” The element “result” is represented by the token “Variable”, element “=” is represented by the token “Assignment Operator”, the element “input1” is represented by the token “Variable”, the element “+” is represented by the token “Addition Operation”, the element “input2” is represented by the token “Variable”, and the token “EndOfLine” or “EOL” represents the end of a source code statement.

The code analysis engine optionally filters out certain tokens deemed to be insignificant, such as comments, whitespace, etc., and code changes that are not of interest (block 404). Each element in a line is replaced with a corresponding token thereby transforming the source code statement into a sequence of tokens where each token corresponds to an element in the original source code statement (block 406).

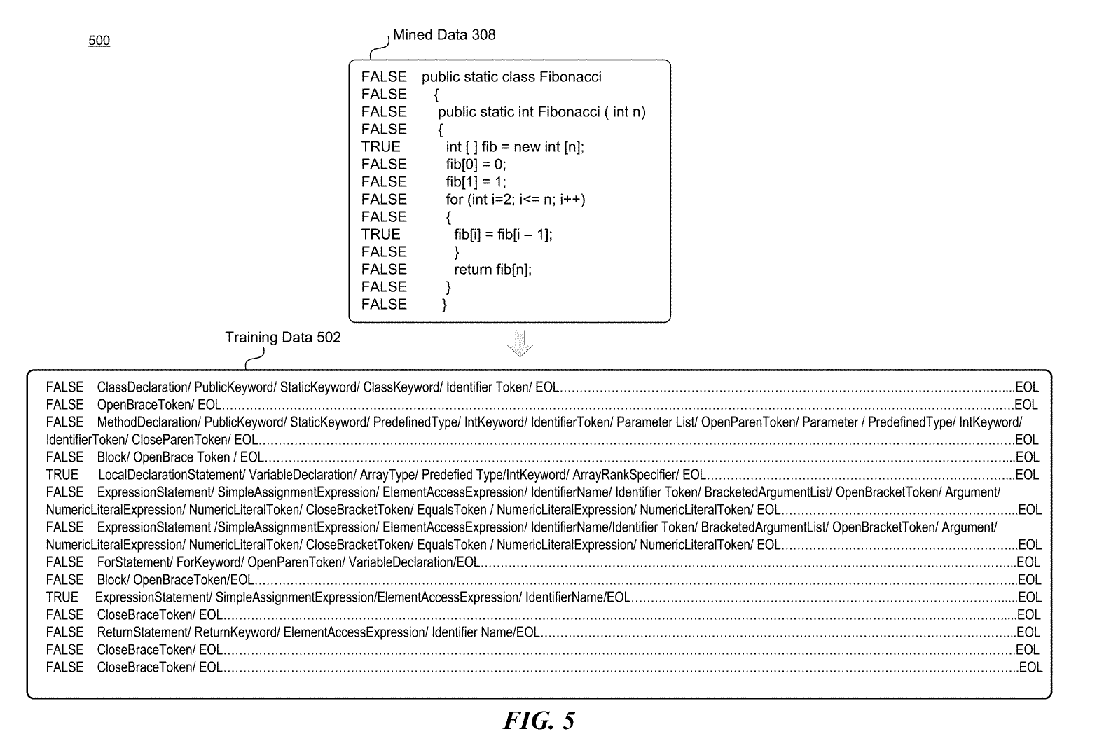

FIG. 5 continues the example shown in FIG. 3 and illustrates the operations 500 of the code analysis engine. Turning to FIG. 5, there is shown the mined data 308 shown in FIG. 3 and the corresponding training data 502 output from the code analysis engine. For each line of source code shown in the mined data 308, there is a corresponding line in the training data 502 which contains the flag indicating whether there is a bug in the line of code and the sequence of tokens that are associated with the line of code. For example, line 310 of mined data 308 is “FALSE public static class Fibonacci” where “FALSE” indicates that there is no bug in the corresponding source code statement “public static class Fibonacci.” The corresponding entry in the training data 502 is “FALSE ClassDeclaration/PublicKeyword/StaticKeyword/ClassKeyword/IdentifierToken/EOL” where token “ClassDeclaration” refers to the entire statement “public static class Fibonacci” representing a class declaration, the token “PublicKeyword” corresponds to “public”, the token “StaticKeyword” corresponds to “static”, the token “ClassKeyword” corresponds to “class” and the token “Identifier Token” corresponds to “Fibonacci.”

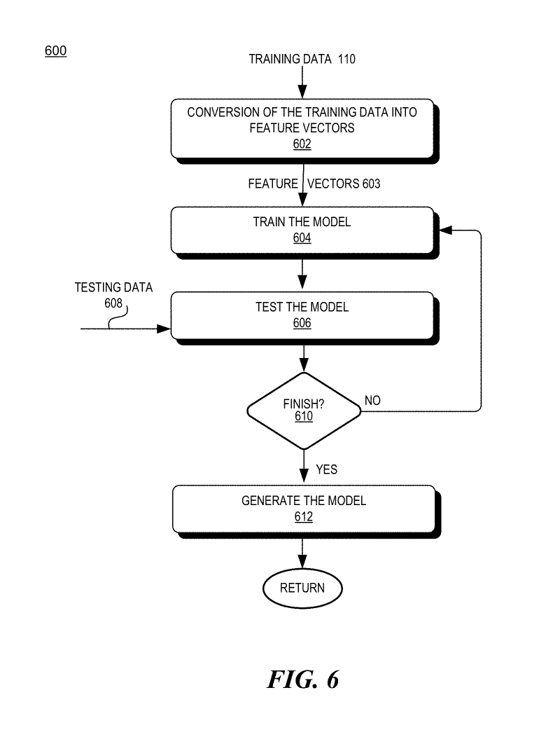

FIG. 6 illustrates a flow diagram of an exemplary method 600 of the training engine. In an aspect of the subject matter disclosed herein, the training engine utilizes machine learning techniques to find patterns in the training data that are highly indicative of a bug. There are various types of machine learning techniques which are well-known, such as support vector machines (SVM), deep neural networks (DNN), recurrent neural networks (RNN), artificial neural networks (ANN), long short term memory (LSTM) and so forth.

In one aspect of the subject matter disclosed herein, the method utilizes a long short term memory (LSTM) neural network as the model for source code bug prediction. It should be noted that this aspect is not constrained to a LSTM neural network and that other probabilistic machine learning techniques may be utilized. The LSTM architecture includes an input layer, one or more hidden layers in the middle with recurrent connections between the hidden layers at different times, and an output layer. Each layer represents a set of nodes and the layers are connected with weights. The input layer xₜ represents an input at time t and the output layer yₜ produces a probability distribution. The hidden layers hₜ maintain a representation of the history of the training data. Gating units are used to modulate the input, output, and hidden-to-hidden transitions in order to keep track of a longer history of the training data.

Typical LSTM architectures implement the following operations:

iₜ=σₜ(Wₓₜxₜ+Wₕₜhₜ₋₁+W_{ci}cₜ₋₁+bᵢ)

fₜ=σ(W_{xf}+Wₕhₜ₋₁W_{cf}Cₜ₋₁b_{f})

cₜ=fₜ⊙cₜ₋₁+iₜ⊙ tan h(Wₓₒxₜ+W_{hc}hₜ₋₁+b_{c})

oₜ=σ(WₓₒxₜWₕhₜ₋₁W_{co}cₜb₀)

hₜ=oₜ⊙ tan h(cₜ)

where iₜ, oₜ, fₜ are input, output and forget gates respectively,

cₜ is memory cell activity,

xₜ and hₜ are the input and output of the LSTM respectively,

⊙ is an element wise product, and

σ is the sigmoid function.

The training engine transforms the windows of the raw training data (e.g., sequences of training data) into a binary representation that is used as the feature vectors. The training engine uses the feature vectors to determine the appropriate weights and parameters for the LSTM model.

In one aspect of the subject matter disclosed herein, each line of the training data is optionally limited to a fixed length of 250 tokens. Lines with less than 250 tokens are padded with EndOfLine tokens. The code analysis engine utilizes only 439 tokens of the grammar of the underlying programming language in order to exclude trivial and superfluous elements. Each token in a line is represented by a bit pattern that includes 439 bits, where each bit represents a particular token. Each line of source code is then represented by 109,750 bits (i.e., 250 tokens multiplied by 439 bits).

A size of a window may be determined by analyzing the success of the model with the testing data. Alternatively, a window may be of a reasonable size based on the available computational resources. The window size may be one. In an exemplary aspect, the window comprises seven (7) source code lines. The window includes a current line along with the immediately preceding three (3) lines and the immediately succeeding three (3) lines. Special padding will be used for both the first and last three (3) lines of source code which may not have immediately preceding/following lines of code. Each window will be labeled with a flag indicating whether the current line has a software bug or not. The training data may include a relatively equal number of lines having bugs and not having bugs in order to reduce potential bias and increase the accuracy of the model. Alternatively, instead of ensuring a relatively equal number of lines having bugs and not having bugs, the ultimate outcome of the model can be scaled by a factor determined by the proportion of lines having bugs to those not having bugs. Lines with less than three elements before padding are ignored since they do not contain a sufficient amount of data that can be of significance. With the window size of seven lines, a single feature vector will contain 768,250 bits (i.e., 109,750 bits per line multiplied by a window size of 7).

Turning to FIG. 6, there is shown an exemplary training phase. The training data 110 is input to the training engine which converts the training data into feature vectors 603 as described above (block 602). The feature vectors 603 are then used by the training engine to generate the weights and parameters of the model (block 604). The model is then tested with testing data 608 in order to determine the accuracy of the model (block 606). If the model does not meet an intended level of accuracy, the model weights may be adjusted to increase the sharpness of the model and/or additional training may be applied to the model. In this situation, the model is not finished (block 610—no) and is retrained (block 604). In the event the model meets the intended level of accuracy or exceeds a number of epochs or time constraint (block 610—yes), the model is deemed trained (block 612).

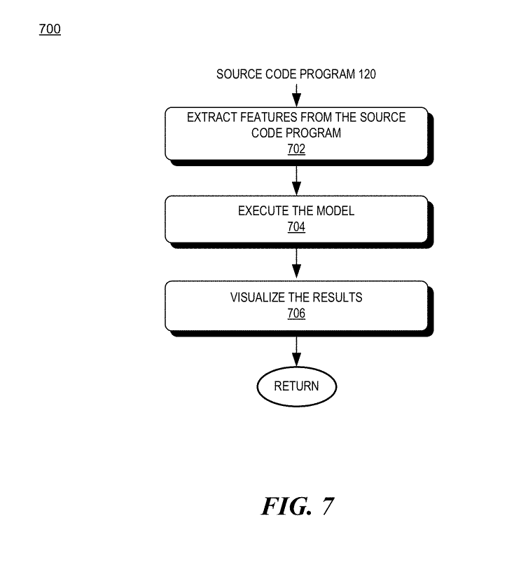

FIG. 7 illustrates a flow diagram of an exemplary method 700 of the execution phase. A source code file 120 is input into the code analysis program to convert the source code statements into the sequence of tokens (block 702). In the execution phase, the source code statements are not labeled with the TRUE and FALSE class labels (block 702). The sequence of tokens is then converted into feature vectors, as discussed above, and input to the model (block 702). The model is applied to these feature vectors and outputs a probability for each source code statement (block 704). The results may then be output to a visualization engine or output as desired (block 706).

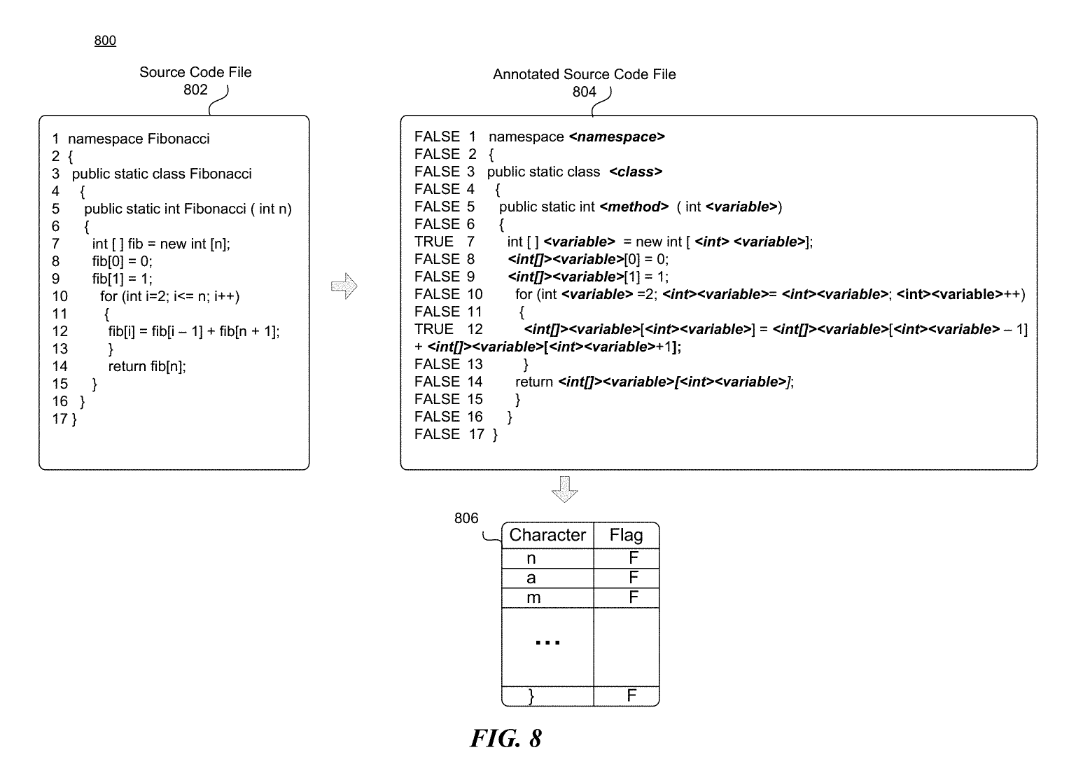

FIG. 8 illustrates a second aspect of the subject matter disclosed herein. This aspect is a variation of the aspect discussed above in FIGS. 1-7 and differs in that only certain elements in a source code statement are transformed into a token. The source code statements are partially tokenized. A pre-configured group of elements are identified and replaced by or concatenated with tokens in the source code file. A token is based on the grammar of the programming language of the source code file. For certain predetermined elements, these elements are replaced with a token that describes its constituent element in the associated grammar. This replacement adds additional context information to the source code file to more particularly identify the characteristics of a software code bug.

Turning to FIG. 8, there is shown an example 800 of the extraction of the features of a source code file in this second aspect. Referring to FIGS. 1 and 8, the data mining engine 106 retrieves a source code file 802 which is sent to the code analysis engine 110. The code analysis engine 110 analyzes the source code file 802 and annotates predetermined elements of the source code file 802 with tokens as shown in annotated source code 804. In the example shown in FIG. 8, the variable, class, method and namespace names have been replaced with a respective token, <variable>, <class>, <method>, <namespace>, that identifies the replaced element as a variable, class, method, namespace respectively. These tokens replace the names originally found in the source code file with a token that identifies a corresponding syntactic element. For example, the word “Fibonacci” in the source code statement “public static class Fibonacci” is replaced with <class> indicating that the source code line is associated with a class declaration. Likewise, the source code statement “int[ ] fib=new int[n]” replaces the variable name “fib” with the token <variable> indicating that “fib” is a variable and replaces “int n” with the tokens “int <variable>” indicating an integer variable.

Each character or chunk of characters of the annotated source code file is then flagged as either being associated with a software bug or not. For example, as shown in table 806 each character in the annotated source code file 804 is associated with a flag. The flag may have values “F” or “T” where “F” indicates that the corresponding character is not associated with a software bug and “T” indicates that the character is associated with a software bug. If chunks are used, then the table would identify whether each chunk is associated with a software bug nor not.

The annotated source code file 804 is then input into the training engine 114 which transforms the annotated source code statements into a binary representation or feature vectors that train a machine learning model, such as a recurrent neural network (RNN). The training engine 114 groups contiguous source code statements preceding a particular source code statement using a window of a certain size into feature vectors which are then used to train the RNN.

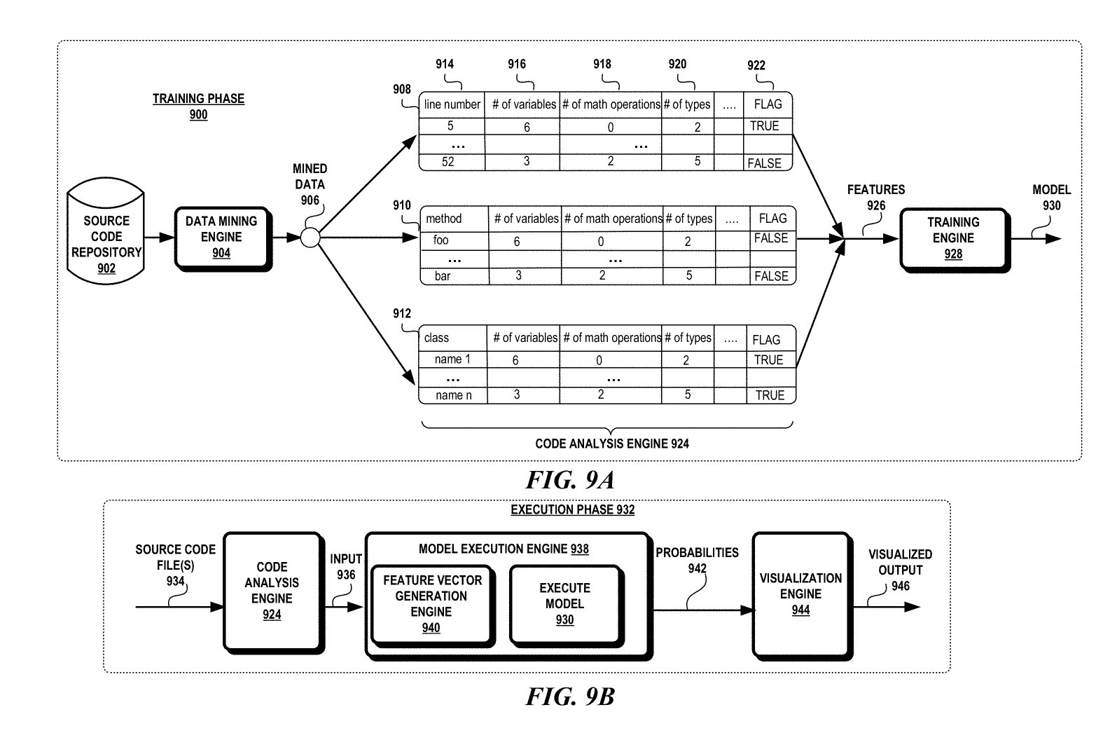

FIGS. 9A-9B illustrate a third aspect of the subject matter disclosure herein, which uses metrics to train a machine learning model. The metrics are based on the syntactic structure of the source code file. These metrics may include, without limitation, measurements or counts of different syntactic elements, such as the number of variables, the number of mathematical operations, the number of a particular data type of elements referenced, the number of loop constructs, the usage of a particular method, and the usage of a particular data type in the source code. These metrics are used to identify the context in which a software bug exists.

Referring to FIG. 9A, there is shown a training phase of a system 900 where the data mining engine 904 searches a source code repository 902 for mined data 906 including source code files with and without software bugs. Each line of source code in a mined source code file is flagged to indicate whether or not that line contains a software bug. A code analysis engine 924 analyzes the mined source code file to generate a table 908, 910, 912 that tabulates metrics for a particular portion of a source code file. The metrics may be generated for each line 914 of the source code file as shown in table 908, for each method of the source code file as shown in table 910, for each class in the source code file as shown in table 912, and for combinations thereof. The metrics may include the number of variables 916, the number of mathematical operations 918, the number of a particular data type referenced 920, the number of loop constructs, the usage of a particular method, and the usage of a particular data type in a line of source code, in a method, or in a class. Each line in a table is then labeled with a flag 922 that indicates whether or not the corresponding line, method or class contains a software bug.

The extracted features 926 are then input to the training engine 928 which transforms them into a binary representation or feature vectors that train a machine learning model 930. The training engine 928 contains a feature vector generation engine 123 and model generation engine 117 as shown in the training engine 114 of FIG. 1. In one aspect, the machine learning model 930 may be an artificial neural network (ANN), such as a feed forward neural network (FNN). The ANN may be trained with testing data including feature vectors associated with source code having a software bug and feature vectors not having software bugs. The training data may be split in any manner intended to achieve the desired goal.

When the ANN has been trained and tested to meet a suitable threshold, the model 930 is ready. FIG. 9B illustrates the execution phase 932 which uses the model 930 on one or more source code files 934. The code analysis engine 924 reads a source code file 934 to extract the metrics which are passed as input 936 to the model execution engine 938. The model execution engine includes a feature vector generation engine 940 that transforms the input 936 into feature vectors that are passed to the model 930. The model 930 generates probabilities representing a likelihood of a portion of source code file having a software bug. The visualization engine 944 receives the probabilities and generates a visual output 946.

Attention now turns to a discussion of the visualization techniques employed by the visualization engine.

Visualization

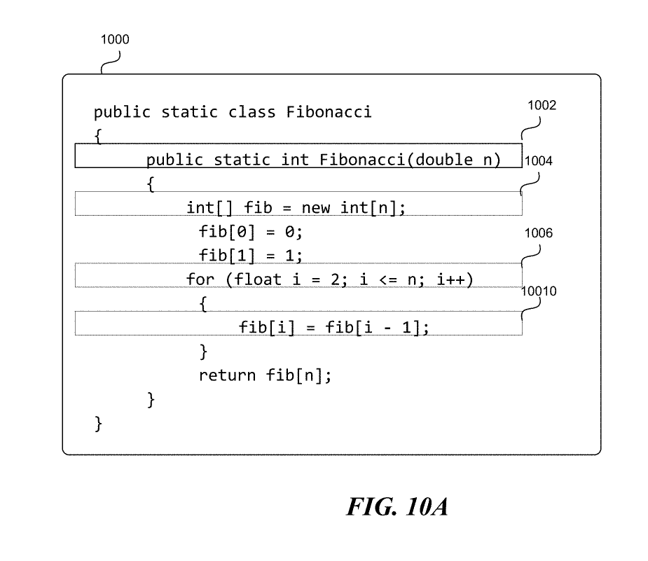

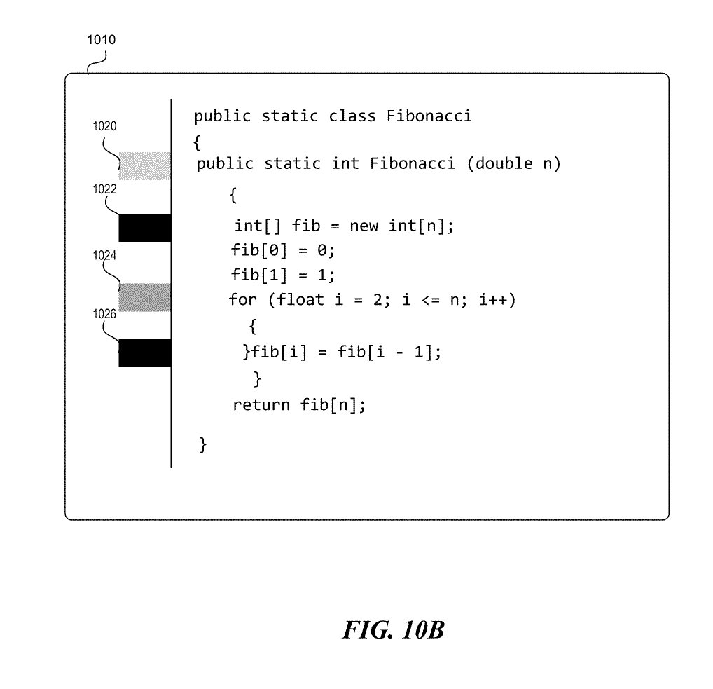

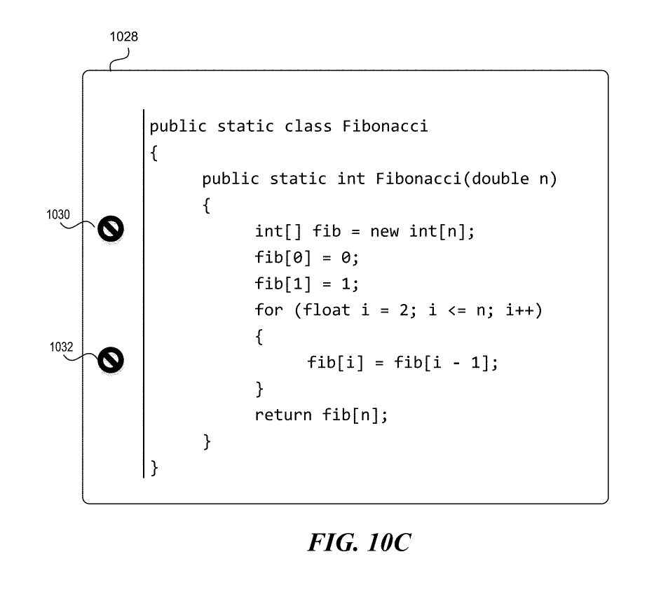

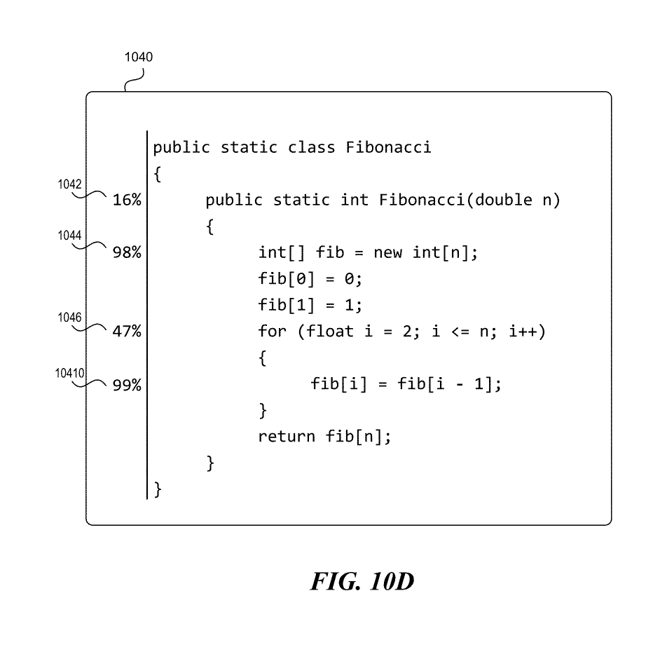

In one aspect of the subject matter discussed herein, the output from the model execution engine 124 may be input to a visualization engine 128 that visualizes the results from the model. In one aspect, the visualization engine 128 displays a portion of the source code file with certain lines of code highlighted in different shades or colors. The different shaded and/or highlighted lines indicate different probabilities that a corresponding line contains a bug. For example, as shown in FIG. 10A, there is shown a segment of a source code file 1000 having four lines of source code enclosed in a box, 1002, 1004, 1006, 1008. These boxes can be highlighted in different colors with each color indicating a particular probability or indicating that the probability associated with a line exceeds a threshold. Alternatively, the boxes can be shaded in one color and the text can be displayed in another color.

In addition, icons can be affixed next to a particular line of source code where the icons indicate different probabilities of the associated line containing a software bug. For example, in FIG. 10B there is shown a segment of a source code file 1010 with shaded boxes 1020, 1022, 1024, and 1026 adjacent to different lines of source code. Shaded boxes 1022 and 1026 may represent a higher likelihood of the adjacent source code lines having a software bug than the source code lines adjacent to shaded boxes 1020 and 1024.

FIG. 10C shows a segment of a source code file 1028 having two icons, 1030, 1032, representing the two source code statements having a high likelihood of a software bug. FIG. 10D shows the numeric value of the probability displayed adjacent to four lines of source code having the highest likelihood of a bug. As shown in FIG. 10D, there is a segment of a source code file 1040 that includes the source code statement “public static int Fibonacci (double n)” has a 16% probability of containing a software bug 1042, the source code statement “int[ ] fib=new int[n]” has a 98% probability of containing a software bug 1044, the source code statement “for (float i=2; i<=n; i++)” has a 47% probability of containing a software bug 1046, and the source code statement “fib[i]=fib[i−1]” has a 99% probability of a software bug 1048.

It should be noted that the subject matter disclosed herein is not limited to a particular virtualization technique or format and that other techniques and formats may be utilized to visualize the output of the machine learning model.

Attention now turns to a discussion of the different applications in which the source code bug prediction technique may be utilized.

Applications

The source code bug prediction technique described herein is utilized to analyze source code files to extract features indicative of patterns that can be used to train a machine learning model to predict the likelihood of the existence of a software bug. However, this technique may be applied to different applications or scenarios to achieve an intended objective.

In one aspect, the techniques described herein may be applied to a specific set of source code files, such as the source code files of a specific developer or group of developers, such as members on the same programming team or project. The source code files written by a particular developer or group of developers may be selected to train a customized model suited for a particular developer, group of developers, and/or team. Each customized model learns the programming habits of the developer, group of developers, and team. In an execution phase, a target source code file can be analyzed by each customized model, that is, by each developer's model, the team's model, or any combination thereof. The results of each customized model can then be visualized with the target source code file. Additionally, the results of each model can be aggregated into a single result. The results of one or more of the models can be weighted so that the results of certain models are given a higher weight than the results of other models. The results of some models can be excluded as well. The application of the various models to a target source code can avoid the detection of issues specific to one developer being incorrectly detected in the source code of another developer.

In yet another aspect, the techniques described herein may be applied to detect hardware bugs in a hardware description language (HDL). It should be noted that the subject matter disclosed herein is not limited to a software bug in source code and may be applied to detect bugs in other languages that adhere to a grammar.

Technical Effect

Aspects of the subject matter disclosed herein pertain to the technical problem of determining the probability of software bugs in a source code file in a more relevant and meaningful manner. The technical features associated with addressing this problem involve a technique that models the context or syntactic structure of portions of a source code file (i.e., source code statements, methods, classes) with and without software bugs in order to generate a machine learning model to predict the probability of a source code file containing software bugs. Accordingly, aspects of the disclosure exhibit technical effects with respect to detecting a software bug in a portion of a source code file by source code files extracting significant syntactic features that yield patterns that can be learned to predict a likelihood of the existence of a software bug.

Exemplary Operating Environment

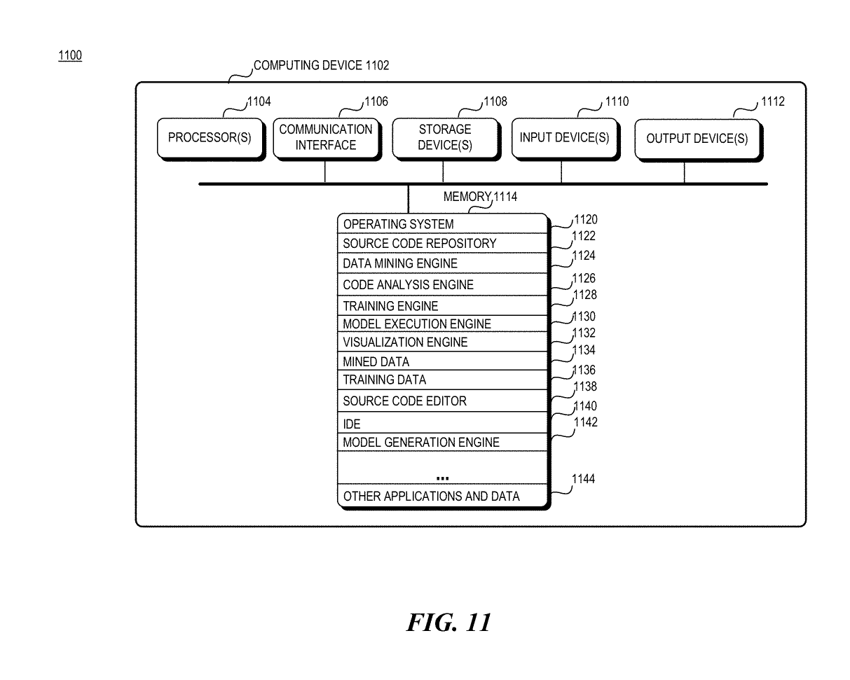

Attention now turns to FIG. 11 for a discussion of an exemplary operating environment. It should be noted that the operating environment 1100 is exemplary and is not intended to suggest any limitation as to the functionality of the embodiments. The embodiments may be applied to an operating environment 1100 utilizing at least one computing device 1102. The computing device 1102 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1100 may be configured in a network environment, a distributed environment, a multi-processor environment, or a stand-alone computing device having access to remote or local storage devices.

The computing device 1102 may include one or more processors 1104, a communication interface 1106, one or more storage devices 1108, one or more input devices 1110, one or more output devices 1112, and a memory 1114. A processor 1104 may be any commercially available or customized processor and may include dual microprocessors and multi-processor architectures. The communication interface 1106 facilitates wired or wireless communications between the computing device 1102 and other devices. A storage device 1108 may be computer-readable medium that does not contain propagating signals, such as modulated data signals transmitted through a carrier wave. Examples of a storage device 1108 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1108 in the computing device 1102. The input devices 1110 may include a keyboard, mouse, pen, voice input device, touch input device, etc., and any combination thereof. The output devices 1112 may include a display, speakers, printers, etc., and any combination thereof.

The memory 1114 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. The memory 1114 may also include one or more external storage devices or remotely located storage devices that do not pertain to propagated signals, such as modulated data signals transmitted through a carrier wave.

The memory 1114 may contain instructions, components, and data. A component is a software program that performs a specific function and is otherwise known as a module, program, application, and the like. The memory 1114 may include an operating system 1120, a source code repository 1122, a data mining engine 1124, a code analysis engine 1126, a training engine 1128, a model execution engine 1130, a visualization engine 1132, mined data 1134, training data 1136, a source code editor 138, an integrated development environment (IDE) 140, a model generation engine 142, and other applications and data 1144.

The subject matter described herein may be implemented, at least in part, in hardware or software or in any combination thereof. Hardware may include, for example, analog, digital or mixed-signal circuitry, including discrete components, integrated circuits (ICs), or application-specific ICs (ASICs). Aspects may also be implemented, in whole or in part, in software or firmware, which may cooperate with hardware.

In addition, the logic flows depicted in the figures do not require the particular order shown, or sequential order, to achieve desirable. Other steps may be provided or steps may be eliminated, from the described flows, and other components may be added to, or removed from, the described systems and devices. Accordingly, other implementations are within the scope of the following claims.

In accordance with aspects of the subject matter described herein, a computer system can include one or more processors and a memory connected to one or more processors. At least one processor is configured to obtain a plurality of source code statements from at least one source code file, where at least one source code file contains a software bug and at least one source code file does not contain a software bug. The source code statements are transformed into a plurality of features with at least one feature representing the context of a software bug and at least one feature representing a context not having a software bug. These features are transformed into feature vectors that train a machine learning model to recognize patterns indicative of a software bug. The machine learning model is used to generate probabilities of a software bug for a target source code file.

The system transforms the plurality of source code statements into a sequence of tokens, where each token is associated with a grammar of the source code file. The system may also transform the plurality of source code statements into features by converting and/or concatenating at least one element of the source code into a token along with the elements of the source code statement. The system may also transform the plurality of source code statements into features by converting each source code statement into a sequence of metrics wherein a metric is associated with a measurement of a syntactic element of source code statement. The machine learning model may be implemented as a LSTM model, RNN, or ANN.

The system visualizes the output of the machine learning model in various ways. The system may visualize one or more source code statement from a target source code file with a corresponding probability for one or more of the source code statements. The visualization may include highlighting a source code statement in accordance with its probability, altering a font size or text color in accordance with its probability, annotating a source code statement with a numeric probability value, and/or annotating a source code statement with an icon representing a probability value. The output of the visualization may be displayed when the probability exceeds a threshold value.

A device can include at least one processor and a memory connected to the at least one processor. The device including a data mining engine, a code analysis engine, a training engine, and a visualization engine. The data mining engine searches a source code repository for source code files. The code analysis engine converts a portion of a source code file having a software bug and a portion of a source code file not having a software bug into a sequence of syntactic elements that represent a context in which a software bug exists and fails to exist. The visualization engine generates a visualization identifying at least one portion of a target source code file having a likelihood of a software bug. The visualization may include a portion of a target source code file and the probabilities associated therewith.

The training engine uses the sequence of syntactic elements to train a machine learning model to predict a likelihood of a software bug in a target source code file. The training engine aggregates a contiguous set of sequences of syntactic elements into a window to generate a feature vector. The contiguous set of sequences includes an amount of sequences of syntactic elements preceding and following a select sequence. The portion of the source code file may include one or more lines of a source code file and/or classes of the source code file.

A method of using a system and device, such as the system and device described above, can include operations such as obtaining a plurality of source code files with and without software bugs. The source code files are mined from change records of a source code repository. Portions of the source code files are converted into a sequence of metrics, where a metric represents a measurement of a syntactic element. The metrics are used to train a machine learning model to predict the likelihood of a software bug in a portion of a target source code file. The portion of a target source code file may include a source code statement, a method and/or a class. The metrics may include one or more of a number of variables, a number of mathematical operations, a number of particular data type of elements referenced, a number of loop constructs, a usage of a particular method and a usage of a particular data type.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system, comprising:
a memory and at least one processor;
the at least one processor configured to:
obtain a plurality of source code statements from at least one source code file, at least one of the plurality of source code statements having a software bug, at least one of the plurality of source code statements not having a software bug;
transform the plurality of source code statements into a plurality of features, at least one of the feature representing a context of a software bug, at least one other feature representing a context not having a software bug;
transform the plurality of features into a plurality of feature vectors;
train a machine learning model using the feature vectors to recognize patterns in a source code file indicative of a software bug; and
generate a probability of a software bug in a target source code file using the machine learning model.

2. The system of claim 1, wherein the at least one processor transforms the plurality of source code statements into a plurality of features by converting each source code statement of the plurality of source code statements into a sequence of tokens, wherein a token is associated with a syntactic element associated with a grammar of the source code file.

3. The system of claim 2, wherein the machine learning model is a long short term memory (LSTM) model.

4. The system of claim 1, wherein the at least one processor transforms the plurality of source code statements into a plurality of features by converting and/or concatenating at least one element in at least one source code statement of the plurality of source code statements into a token, wherein a token is associated with a syntactic element associated with a grammar of the source code file.

5. The system of claim 4, wherein the machine learning model is a recurrent neural network (RNN).

6. The system of claim 1, wherein the at least one processor transforms the plurality of source code statements into a plurality of features by converting each source code statement of the plurality of source code statements into a sequence of metrics, wherein a metric is associated with a measurement of a syntactic element of a source code statement.

7. The system of claim 6, wherein the machine learning model is an artificial neural network (ANN).

8. The system of claim 1, wherein the at least one processor is further configured to:
visualize one or more source code statements from a target source code file with a corresponding probability for at least one of the one or more source code statements.

9. The system of claim 8, wherein the visualization of the one or more source code statements includes at least one of:
highlighting a source code statement in accordance with a probability;
altering a font size or text color of a source code statement in accordance with a probability;
annotating a source code statement with a numeric probability value; and/or
annotating a source code statement with an icon representing a probability value;

10. The system of claim 8, wherein the visualization is displayed when a probability of the one or more source code statements exceeds a threshold value.

11. A method, comprising:
obtaining a plurality of source code files, at least one source code file of the plurality of source code files having a software bug, at least one source code file of the plurality of source code files not having a software bug;
converting at least one portion of a source code file of the plurality of source code files into a sequence of metrics, a metric representing a measurement of a syntactic element; and
using the sequence of metrics to train a machine learning model to predict a likelihood of a software bug in a portion of a target source code file.

12. The method of claim 11, wherein the portion of the target source code file includes a source code statement, a method, and/or a class.

13. The method of claim 11, wherein obtaining a plurality of source code files further comprises:
mining change records of a source code repository for source code files having been changed to fix a software bug.

14. The method of claim 11, wherein the sequence of metrics includes one or more of a number of variables, a number of mathematical operations, a number of a particular data type of elements referenced, a number of loop constructs, a usage of a particular method, and a usage of a particular data type.

15. A device, comprising:
a memory and at least one processor;
a data mining engine including instructions that when executed on the at least one processor searches a source code repository for a plurality of source code files;
a code analysis engine including instructions that when executed on the at least one processor converts a portion of at least one source code file having a software bug into a sequence of syntactic elements that represent a context in which a software bug exists and converts a portion of at least one source code file not having a software bug into a sequence of syntactic elements that represent a context in which a software bug fails to exist; and
a training engine including instructions that when executed on the at least one processor uses the sequence of syntactic elements that represent a context in which a software bug exists and the sequence of syntactic elements that represent a context in which a software bug fails to exist to train a machine learning model to predict a likelihood of a software bug in a target source code file.

16. The device of claim 15, wherein the training engine includes further instructions that when executed on the at least one processor aggregates a contiguous set of sequences of syntactic elements into a window to generate a feature vector.

17. The device of claim 16, wherein the contiguous set of sequences includes an amount of sequences of syntactic elements preceding a select sequence and an amount of sequences of syntactic element following the select sequence.

18. The device of claim 15, wherein the portion of the at least one source code file includes one or more lines of source code and/or classes of the at least one source code file.

19. The device of claim 15, further comprising:
a visualization engine that generates a visualization identifying at least one portion of a target source code file having a likelihood of a software bug.

20. The device of claim 19, wherein the visualization includes the at least one portion of the target source code and probabilities associated with the at least one portion of the target source code.
